(19) United States
(12) Patent Application Publication
(10) Pub. No.: US 2024/0176662 A1
(43) Pub. Date: May 30, 2024

(54) SUPPORT FOR DYNAMIC SCALING

(71) Applicant: Dell Products L.P., Round Rock, TX (US)

(72) Inventors: Jingjing Liu, Shanghai (CN); Lu Lei, Shanghai (CN); Julius Jian Zhu, Shanghai (CN)

(21) Appl. No.: 18/162,539

(22) Filed: Jan. 31, 2023

(30) Foreign Application Priority Data
Nov. 30, 2022 (CN) 202211526464.7

(51) Int. Cl. G06F 9/50

(52) U.S. Cl. CPC G06F 9/5027

(57) ABSTRACT

Support for dynamic scaling is provided. An example method includes: acquiring a current value of a metric associated with a plurality of components of an application; determining a target number of replicas of at least one component of the plurality of components based on the current value of the metric and a scaling policy for the plurality of components; and updating a configuration manifest of the application based on the target number of replicas of the at least one component. In this manner, the configuration manifest of the application can be automatically updated based on metric values of the components at runtime and a custom scaling policy, thereby achieving dynamic scaling of various components of the application without additional user effort to implement separate dynamic scaling mechanisms.

### RELATED APPLICATION

The present application claims the benefit of priority to Chinese Patent Application No. 202211526464.7, filed on Nov. 30, 2022, which application is hereby incorporated into the present application by reference herein in its entirety.

### TECHNICAL FIELD

Embodiments of the present disclosure relate to the field of computers, and more particularly, to a method, an electronic device, and a computer program product for supporting dynamic scaling.

### BACKGROUND

With the development of cloud computing technology, more and more applications are deployed and run in containers of clusters. A container orchestration platform can automatically deploy applications, allocate computing resources to containers running the applications as needed, and support dynamic scaling of the applications. That is, when the business volume of applications increases, more containers are launched to meet the business demand, and when the business volume decreases, containers are reduced to save cost.

The existing dynamic scaling mechanism of container orchestration platforms is simple and thus difficult to meet dynamic scaling needs of complex applications, and users need to spend a lot of effort to separately implement dynamic scaling mechanisms of applications.

### SUMMARY

The following presents a simplified summary of the disclosed subject matter in order to provide a basic understanding of some aspects of the disclosed subject matter. This summary is not an extensive overview of the disclosed subject matter. It is intended to neither identify key or critical elements of the disclosed subject matter nor delineate the scope of the disclosed subject matter. Its sole purpose is to present some concepts of the disclosed subject matter in a simplified form as a prelude to the more detailed description that is presented later.

According to embodiments of the present disclosure, a solution for supporting dynamic scaling is provided.

According to a first embodiment of the present disclosure, a method for supporting dynamic scaling is provided, comprising: acquiring a current value of a metric associated with a plurality of components of an application; determining a target number of replicas of at least one component of the plurality of components based on the current value of the metric and a scaling policy for the plurality of components; and updating a configuration manifest of the application based on the target number of replicas of the at least one component.

In a container orchestration system, a user uses a configuration manifest (e.g., in the yaml format) to define the numbers of replicas required by components of an application, and the container orchestration system automatically performs dynamic scaling of the components based on the configuration manifest. In such manner, the configuration manifest of the application can be automatically updated based on metric values of the components at runtime and a custom scaling policy, thereby achieving dynamic scaling of various components of the application without additional user effort to implement separate dynamic scaling mechanisms.

According to a second embodiment of the present disclosure, an electronic device is provided, including: at least one processing unit, and at least one memory coupled to the at least one processing unit and storing instructions for execution by the at least one processing unit, where the instructions, when executed by the at least one processing unit, cause the computing device to perform a method. The method includes: acquiring a current value of a metric associated with a plurality of components of an application; determining a target number of replicas of at least one component of the plurality of components based on the current value of the metric and a scaling policy for the plurality of components; and updating a configuration manifest of the application based on the target number of replicas of the at least one component.

According to a third embodiment of the present disclosure, a computer program product is provided, including machine-executable instructions, where the machine-executable instructions, when executed by a device, cause the device to perform operations comprising acquiring a current value of a metric associated with a plurality of components of an application, determining a target number of replicas of at least one component of the plurality of components based on the current value of the metric and a scaling policy for the plurality of components, and, updating a configuration manifest of the application based on the target number of replicas of the at least one component.

### BRIEF DESCRIPTION OF THE DRAWINGS

The above and other features, advantages, and aspects of embodiments of the present disclosure will become more apparent in conjunction with the accompanying drawings and with reference to the following detailed description. In the accompanying drawings, identical or similar reference numerals represent identical or similar elements, in which:

FIG. 1 illustrates a block diagram of an example environment in which some embodiments of the present disclosure may be implemented;

FIG. 2 illustrates a schematic block diagram of a system for supporting dynamic scaling according to an embodiment of the present disclosure;

FIG. 3 illustrates a schematic flow chart of a method for supporting dynamic scaling according to an embodiment of the present disclosure;

FIG. 4 illustrates a schematic diagram of a process for determining a target number of replicas of a component of an application according to an embodiment of the present disclosure;

FIG. 5 illustrates a schematic diagram of a process for performing dynamic scaling based on a configuration manifest according to an embodiment of the present disclosure; and

FIG. 6 illustrates a schematic block diagram of an example device that may be used to implement some embodiments of the present disclosure.

### DETAILED DESCRIPTION

The embodiments of the present disclosure will be described in more detail below with reference to the accompanying drawings. Although the accompanying drawings show some embodiments of the present disclosure, it should be understood that the present disclosure can be implemented in various forms, and should not be explained as being limited to the embodiments stated herein. Rather, these embodiments are provided for understanding the present disclosure more thoroughly and completely. It should be understood that the accompanying drawings and embodiments of the present disclosure are for illustrative purposes only, and are not intended to limit the protection scope of the present disclosure.

In the description of embodiments of the present disclosure, the term “include” and similar terms thereof should be understood as open-ended inclusion, that is, “including but not limited to.” The term “based on” should be understood as “based at least in part on.” The term “an embodiment” or “the embodiment” should be understood as “at least one embodiment.” The terms “first,” “second,” and the like may refer to different or identical objects. Other explicit and implicit definitions may also be included below. In addition, all specific numerical values herein are examples, which are provided only to aid in understanding, and are not intended to limit the scope.

The following terms and their explanations are provided to facilitate understanding of the embodiments of the present disclosure without limiting the scope of the present disclosure.
Kubernetes (referred to as “k8s”): an open-source container orchestration engine that supports automated deployment, large-scale scalability, and application containerization management.
Container: an executable unit of software that encapsulates application code and its libraries and dependencies in a common way, so that containers can be run anytime and anywhere, including clusters on the desktop, in a conventional computing environment, or at a cloud.
Container set: a set of containers used to accomplish a specified business. The container orchestration platform allocates and manages computing resources in units of container collections. In the k8s, such container set is defined as a pod.
HPA (Horizontal Pod Autoscaler): a horizontal pod autoscaler for automatically adjusting Deployment/StatefulSet/ReplicaSet in the k8s according to processor resource utilization, memory usage, or custom metrics to achieve horizontal auto-scaling of pods, thus making the scale of deployment close to the load of the actual business.
Deployment: an object in the k8s environment for informing the k8s how to create and modify pod instances running applications.
StatefulSet: an object in the k8s environment for managing stateful applications.
ReplicaSet: an object in the k8s environment for maintaining running of a set of pod instances, with the main role of ensuring that a certain number of pods can run properly in the cluster.
Custom resource: an object in the k8s environment that extends from the k8s application programming interface (API) or allows users to customize new resources so as to extend k8s functions.

As mentioned above, the container orchestration platform is used for automated deployment and management of applications and supports dynamic scaling of applications. The scaling includes three levels: cluster scaling, vertical scaling, and horizontal scaling. The cluster scaling refers to changing the scale of a cluster by adding or removing nodes and computing resources, which results in increased costs. The vertical scaling and horizontal scaling use existing computing resources to improve system performance or throughput. In the vertical scaling, quantities of processors and memories allocated to a container/container set are adjusted, but data migration or service suspension is required because applications in the container are in a running state. The horizontal scaling, which dynamically adjusts the number of replicas or instances of a container/container set, is the more commonly used scaling approach.

Some container orchestration systems provide built-in controllers to achieve horizontal scaling based on runtime metrics of applications and predefined policies. For example, the HPA of the k8s only supports dynamic scaling using its built-in resources (e.g., StatefulSet, Deployment, and ReplicaSet objects). However, complex applications widely use custom resources and have complex resource configurations and dynamic scaling policies. The existing dynamic scaling mechanism can hardly meet such requirements, resulting in that users need to spend a lot of effort to separately implement the dynamic scaling mechanisms for applications, so it is not pervasive. On the other hand, after the HPA performs dynamic scaling, once a dedicated controller of the application finds that the configuration manifest (e.g., in the yaml format for custom resources) of the application does not match the actual number of replicas of components, it will perform scaling to modify the actual number of replicas of components back to the number in the configuration manifest, resulting in repeated modifications and that effective dynamic scaling cannot be achieved.

In view of this, an embodiment of the present disclosure provides a method for supporting dynamic scaling. The method is applicable to an application with a configuration manifest that defines the components of the application and their corresponding desired numbers of replicas. In this method, a current value of a metric associated with a plurality of components of an application is acquired. Then, a target number of replicas of at least one component of the plurality of components is determined based on the current value of the metric and a scaling policy for the plurality of components, and a configuration manifest of the application is updated using the determined target number of replicas. Since the container orchestration system is capable of automatically performing dynamic scaling of components based on the configuration manifest, based on such an approach, it is possible to implement dynamic scaling of the components of the application by automatically updating the configuration manifest of the application without additional user effort to implement separate dynamic scaling mechanisms, thus having broader pervasiveness.

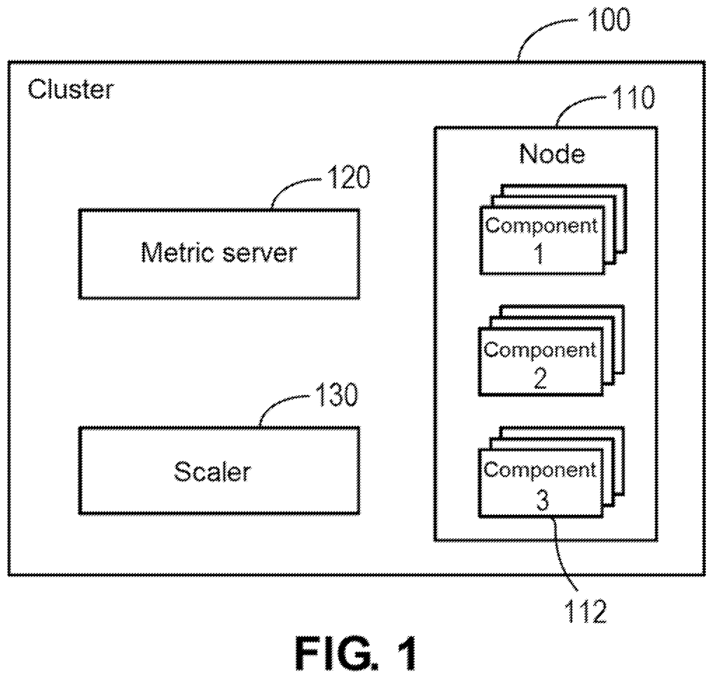

Some example embodiments of the present disclosure will continue to be described below with reference to FIGS. 1 to 6.

FIG. 1 illustrates a block diagram of an example environment according to some embodiments of the present disclosure. The example environment depicts example cluster 100 in general. As shown, cluster 100 includes node 110, metric server 120, and scaler 130.

Node 100 provides an operating environment for a plurality of components 112 of an application. In node 110, corresponding services are provided by running a number of replicas or instances of component 112. The replicas of component 112 may run in a container set. The container orchestration platform may allocate computing resources, such as CPU resources, memory resources, etc., for container sets according to configuration information. For example, in the k8s platform, the request and limit of CPU resources and memory resources can be specified for each container set.

The business load of component 112 may vary over time, which may affect the performance of services provided by the component in consideration of the limit on computing resources. Therefore, the number of container sets running component 112 may be adjusted by a horizontal scaling mechanism. During peak business periods, more container sets are created to run more replicas of the component, so as to meet the business performance, or during low business periods, container sets are reduced to run fewer replicas of the component, thereby reducing costs.

In cluster 100, metric server 120 is used to acquire a metric for component 112 from node 110, including CPU utilization, memory usage, and so on. As an example, in the k8s cluster, metric server 120 may acquire a metric associated with component 112 via a Kubelet module (not shown) in node 110. In some embodiments, metric server 120 may also acquire other types of metrics, such as requests per second, throughput, etc., of component 112.

Scaler 130 is configured to control the creation, running, and deletion of replicas of component 112 in node 110. Scaler 130 may acquire the current value of the metric for component 112 from metric server 120. The current value of the metric may be an instantaneous value obtained by measurement or an average value or total value over a period of time. Scaler 130 then determines, based on the scaling policy for component 112 and the current value of the metric, whether to perform dynamic scaling. In some embodiments, the scaling policy may indicate the performance that component 112 needs to meet, and thereby calculate the number of replicas of component 112 needed to meet that performance. If the calculated number of replicas is greater than the current number of replicas, upward scaling (also referred to as “capacity expansion”) may be performed to increase the number of replicas of component 112; and if the calculated number of replicas is less than the current number of replicas, downward scaling (also referred to as “capacity reduction”) may be performed to reduce the number of replicas of component 112. For example, in the k8s environment, scaler 130 may change the number of replicas of component 112 in node 110 by updating the corresponding resources (Deployment/StatefulSet/Replicaset) of component 112.

An example environment in which embodiments of the present disclosure can be implemented has been described above with reference to FIG. 1. It should be understood that embodiments of the present disclosure may also be implemented in different environments. For example, cluster 100 may include more nodes and metric servers, and cluster 100 is not limited to the k8s cluster.

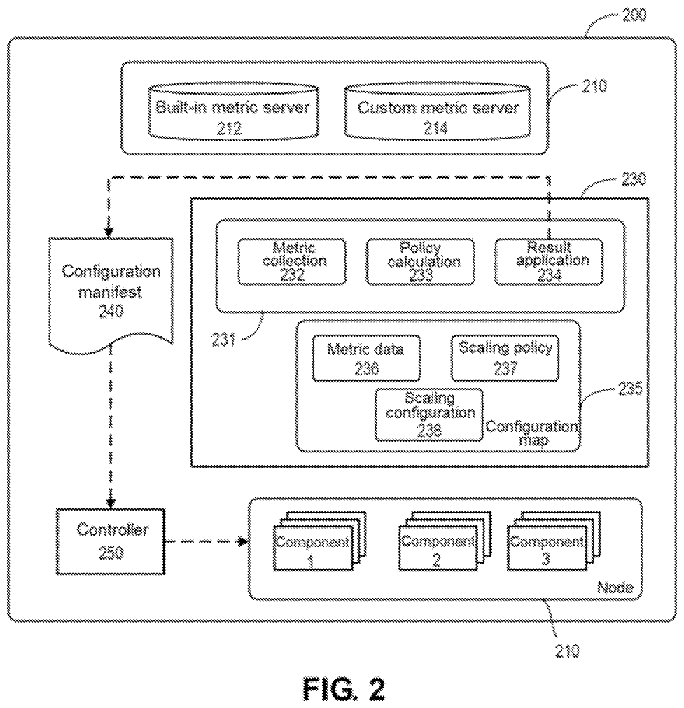

FIG. 2 illustrates a schematic block diagram of system 200 for supporting dynamic scaling according to an embodiment of the present disclosure. System 200 may be implemented in cluster 110. As illustrated, system 200 includes node 210, metric server 220, scaler 230, configuration manifest 240, and controller 250.

Scaler 230 includes scaling processing module 231 and configuration map 235. Scaling processing module 231 may be triggered periodically to monitor the running state of components in node 210 and to achieve dynamic scaling when needed. Configuration map 235 is configured to store data related to dynamic scaling.

In response to being triggered, metric collection submodule 232 in scaling processing module 231 acquires measured values of one or more metrics for a component from metric server 220 to sense the current state of the component. In some embodiments, metric collection submodule 232 may acquire data on CPU utilization and memory usage from built-in metric server 212 of the container orchestration platform (e.g., the k8s), and may also acquire custom metrics, such as requests per second, throughput, etc., from custom metric server 214. In some embodiments, information about the metric server associated with the component may be stored in scaling configuration 238 of configuration map 235, whereby metric collection submodule 232 may determine, by accessing scaling configuration 238, a metric server to be accessed, and acquire the measured value of the corresponding metric. Metric collection submodule 232 may store the acquired measured value of the metric at metric data 236 in configuration map 235.

Policy calculation submodule 233 then acquires the measured value of the component from metric data 236 and determines the target number of replicas of the component based on scaling policy 237.

Conventional scaling policies only calculate the number of replicas (usually taking the maximum of the numbers of replicas calculated for the metrics) that satisfies all target metric values, but the number of replicas obtained in this manner may be incorrect. For example, in a scenario where data is processed based on data shards, assuming that there are 5 data shards and the target number of replicas obtained by the conventional method is 6, there will be one idle component replica if the capacity expansion is performed in this manner. Therefore, in some embodiments, in addition to the target metric value, i.e., the level of performance that the user wants the component to have, scaling policy 237 may further include a limit on the number of replicas for the component for indicating that the number of replicas of the component should not exceed the corresponding number. Scaling policy 237 may also include other factors to improve the flexibility of dynamic scaling.

Policy calculation submodule 233 notifies the calculated target number of replicas to result application submodule 234. The target number of replicas is then updated by result application submodule 234 to configuration manifest 240 of the application. Configuration manifest 240 records the desired number of replicas for each component of the application. For example, in the k8s, the application may be implemented with custom resources, and the desired number of replicas for each component may be specified by means of custom resource definition (CRD).

Dynamic scaling of the component is then performed automatically by controller 250 based on configuration manifest 240. For example, in the k8s, StatefulSet/Deployment/ReplicaSet objects corresponding to the component can be updated by using a generic custom resource (CR) controller, thereby increasing or decreasing the number of replicas of the component in node 210.

An example system for supporting dynamic scaling has been described above with reference to FIG. 2. It should be understood that some modules or units of system 200 may be omitted without departing from the scope of the present disclosure.

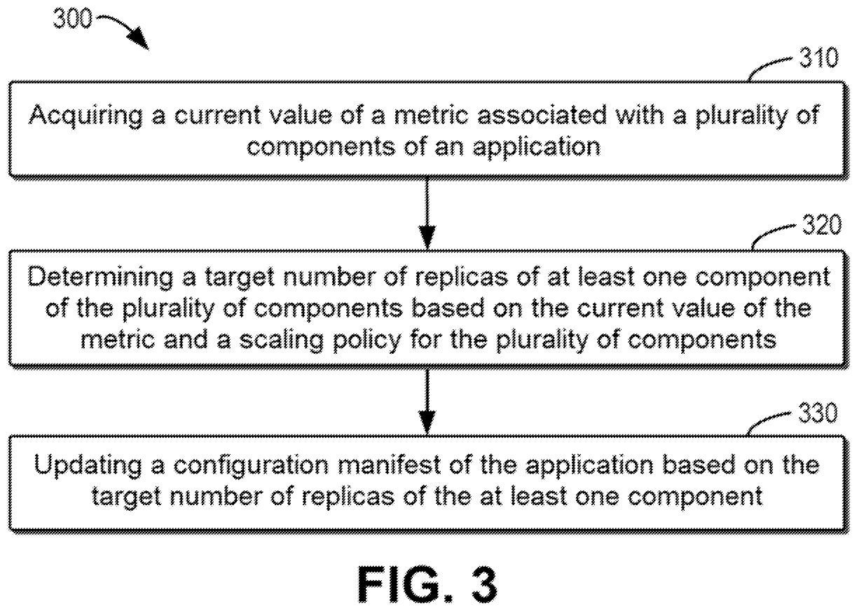

FIG. 3 illustrates a schematic flow chart of a method for supporting dynamic scaling according to an embodiment of the present disclosure. Method 300 may be implemented by cluster 100 shown in FIG. 1 or system 200 shown in FIG. 2. It should be understood that method 300 may also include additional actions not shown and/or may omit actions shown, and the scope of the present disclosure is not limited in this regard. For ease of illustration, method 300 is described in conjunction with FIG. 2.

At block 310, a current value of a metric associated with a plurality of components of an application is acquired. The application may be defined to include a plurality of components, where each component provides a corresponding business. As mentioned above, a container or container set is deployed in node 210 for each component to run the component. During running of the component, the value of a metric associated with the component is measured and stored in metric server 220 as the current value.

Generic metrics, such as CPU utilization, memory usage, etc., may be acquired from built-in metric server 212 provided by the container orchestration platform. In some embodiments, the user may set custom metric server 214 and the current value of the desired metric in scaling configuration 238. As a result, the metric server, and more specifically, custom metric server 214, can be determined based on scaling configuration 238, and the current value of the metric can be acquired from the metric server.

An example scaling configuration is provided below.

```
  “metrics-providers”: {
    “influxdbs”: {
      “testdb”: {
        “host”: “influx-1”,
        “port”: “8086”,
        “username”: “admin”,
        “password”: “password”,
        “database”: “testdb”,
        “queries”: {
          “write_latency”: {
            “query”: “select sum(last) from (select last(mean) from
total_write_latency_ms group by host)”
          },
          “write_latency_percentile_90”: {
            “query”: “select sum(*) from (select last(*) from
total_write_latency_ms_percentile where phi=‘0.9’ group by host)”
          }
        }
      }
    },
    “rests”: {
      “testapp”: {
        “url”: “http://svc-1:10080”,
        “username”: “admin”,
        “password”: “password”,
        “apis”: {
          “shard_count”: {
            “path”: “/v1/scopes/dataPlaneScope/streams”,
            “method”: “GET”,
            “selector”: “streams[*].scalingPolicy.minSegments.sum( )”
          }
        }
```

Here, testdb of the custom metric server InfluxDB and testapp of REST are specified. In this example, there are two InfluxDB queries “write_latency” and “write_latency_percentile_90” for the database testdb. In addition, there is also a REST API “shard_count” located under the “testapp” endpoint, where this endpoint defines the link URL, username, password, request header, and multiple APIs. For each API, a relative path, method, and selector are defined, where the “selector” defines a JSON path to the REST response, from which a value can be derived.

Metric collection submodule 232 is responsible for collecting the current metric value from each metric server and storing it in metric data 236. The collected metric values may include the current value of the metric for each component as well as the metric for the node.

An example of the collected metric values is provided below.

```
controller: ‘{“cpu”: {“averageValue”: “5.44520200”}, “cpu_m”: {“averageValue”:
“8.167803000”},
    “memory”: {“averageValue”: “96.82235717773437500”}, “memory_M”: {“averageValue”:
    “519.811072”}}'
  worker: ‘{“cpu”: {“averageValue”: “1.236860944444444444444444444”}, “cpu_m”:
    {“averageValue”: “22.263496000”}, “memory”: {“averageValue”:
“24.45266723632812500”},
    “memory_M”: {“averageValue”: “1312.792576”}, “##rest##testapp##shard_count”:
{“totalValue”: 20},
    “##influx##testdb##request_latency”: {“totalValue”: 200}}’
  node: ‘{“cpu”: {“averageValue”: “3.034003966666666666666666666”}, “memory”:
{“averageValue”:
    “16.60831503058589462507203038”}, “cpu_m”: {“totalValue”: “1456.321904000”,
“totalCapacity”:
    “48000”}, “memory_M”: {“totalValue”: “33814.646784”, “totalCapacity”:
“202382.147584”}}’
```

In this example, there are two components “controller” and “worker.” Take “worker” as an example, “cpu” indicates the average CPU utilization (the current CPU usage divided by the number of CPU requests), and “cpu_m” indicates the average CPU usage (in permillage), “memory” indicates the average memory usage, and “memory_M” indicates the average memory used per controller in megabytes. These values may be acquired from built-in metric server 212, for example, the Merics server for the k8s. Also, it needs to be noted that “##rest##testapp##shard_count” indicates the metric value acquired from the shard_count API (defined in scaling configuration 238, as described above) provided from the custom metric server REST testapp. “##influx##testdb##request_latency” indicates the metric value acquired using the request_latency query (also defined in scaling configuration 238) provided by the custom metric server influxDB testdb.

Then, at block 320, a target number of replicas of at least one component of the plurality of components is determined based on the current value of the metric and a scaling policy for the plurality of components.

Policy calculation submodule 233 may access metric data 236 to acquire the current value of the metric for the component, and in some embodiments, may also acquire the current value of the metric for the node. Policy calculation submodule 233 may also access scaling policy 237 in configuration map 235 to acquire the policy for the component and, optionally, acquire the policy of the node. Policy calculation submodule 233 may then determine the target number of replicas of the component based on the acquired current value of the metric and the scaling policy.

The node policy defines a target CPU value and a target memory value for the node where the application is located. If the acquired current values of the CPU and the memory for the node exceed the target CPU value and the target memory value, upward scaling is not allowed.

An example node policy is illustrated below.

```
node: ‘{“metrics”: [
  {“name”: “cpu”, “targetTotalValue”:“70”},
  {“name”: “memory”, “targetTotalValue”:“70”}]}’
```

Here, a target value of the CPU metric is specified to be 70%, and a target value of the memory metric is specified to be 70%.

The component scaling policy defines different scaling parameters for each component. The scaling parameters may include a minimum scale factor, a maximum scale factor, a list of metrics, and a list of restrictions. Policy calculation submodule 233 may calculate the target number of replicas of the component based on these parameters.

An example component scaling policy is illustrated below.

```
worker: ‘{“minScaleFactor”: 1, “maxScaleFactor”: 2,
  “metrics”: [
    {“name”:“cpu_m”, “targetAverageValue”: “3000”},
    {“name”: “memory_M”, “targetAverageValue”:“3000”},
    {“name”: “##influx##pravega## write_latency”,
    “targetAverageValue”: “200”}],
  “retrict”: [
    {“name”: “##rest##testapp##shard_count”, “targetAverageValue”:
    “1”}]}’
```

Here, “metrics” (list of metrics) is used to calculate the desired number of replicas based on the target value. In this example, three metrics are defined for the “worker” component: cpu_m, memory_M, and write_latency and their corresponding target values. cpu_m indicates the average CPU usage of the component. memory_M indicates the average memory usage of the component. write_latency indicates the write latency found from the query of influxdb.

“restrict” (list of restrictions) is used to calculate a limit number for the number of replicas based on the target value. When dynamic scaling is performed, the number of replicas of the component is not allowed to exceed the limit number calculated based on the restrictions. In this example, there is a restriction “shard_count” that indicates the average number of data shards each component has. With this restriction, each component replica in the node has at least one data shard, thus avoiding the creation of empty replicas with no data shard.

In this example, minScaleFactor indicates the minimum scale factor, maxScaleFactor indicates the maximum scale factor, and the two are used to calculate the range of the target number of replicas for the replicas. In addition, the component policy may include an indicator as to whether downward and/or upward scaling is allowed. For example, downward scaling, i.e., capacity reduction, is generally not allowed for components such as those implementing cloud storage.

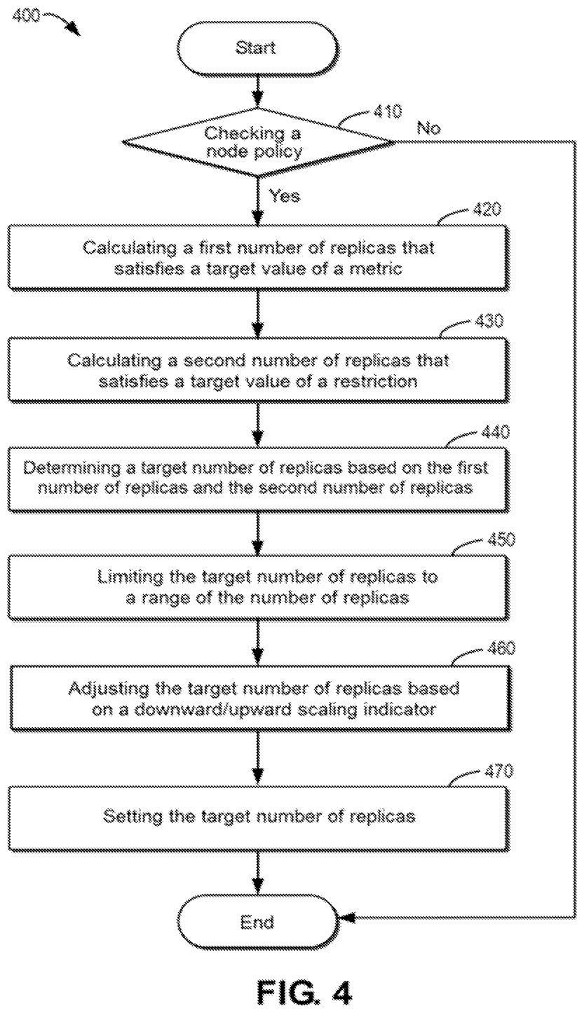

FIG. 4 illustrates a schematic diagram of process 400 for determining a target number of replicas of a component according to an embodiment of the present disclosure. Process 400 may be a specific implementation of block 320. One or more steps in process 400 may be omitted.

At block 410, a node policy is checked. In some embodiments, a current value of a metric associated with a node where an application is located is acquired, for example, the CPU utilization and the memory usage for the node, or other values obtained based on these values. Then, it is determined, based on the current value of the metric for the node and a scaling policy for the node, whether dynamic scaling is allowed to be performed, wherein the scaling policy for the node may specify a target value of the metric associated with the node. The node policy is checked by comparing the current value with the target value. If the check fails, for example, the current value exceeding the target value, the dynamic scaling is not allowed to be performed, and the process ends.

If the check succeeds, process 400 proceeds to block 420 to calculate a first number of replicas that satisfies the target value of the metric. In the case where the list of metrics for the component policy includes a plurality of metrics, the desired number of replicas will be calculated for each metric, the desired number of replicas satisfies the target value of the corresponding metric, and then the maximum number of replicas is selected as the first number of replicas. As a result, the second number of replicas satisfies the target values of all metrics. The desired number of replicas for each metric may be calculated according to the following equation:

Desired number of replicas=ceil[current number of replicas*(current value/target value)]

Here, ceil means rounding up.

As an example, referring to the component scaling policy as illustrated above, if the current number of replicas is 2, the current cpu_m value is 9000, and the target cpu_m value is 3000, then the desired number of replicas for cpu_m is 6, i.e., ceil(2*(9000/3000)). As a result, by traversing all the metrics, the first number of replicas v based on the metrics is obtained.

At block 430, a second number of replicas that satisfies the target value of the restriction is calculated. In the case where the list of metrics for the component policy includes a plurality of restrictions, the limit number of replicas will be calculated for each restriction, the limit number of replicas satisfies the target value of the corresponding restriction, and then the minimum number of replicas is selected as the second number of replicas. As a result, the second number of replicas satisfies the target values of all the restrictions. The limit number of replicas for each metric may be calculated according to the following equation:

Limit number of replicas=floor[current number of replicas*(current value/target value)]

Here, floor means rounding down.

As an example, referring to the component policy as illustrated above, if the current number of replicas is 2, there are 3 data shards, and the target average number of data shards is 1, then the limit number of replicas for the average data shard restriction is 3, i.e., floor (2*(3/2)/1). As a result, by traversing all the restrictions, the second number of replicas v1 based on the restrictions is obtained.

At block 440, a target number of replicas is determined based on the first number of replicas and the second number of replicas. In some embodiments, the minimum of the first number of replicas and the second number of replicas is selected as the target number of replicas, i.e., the target number of replicas v=min(v, v1). As a result, even if the metric-based

At block 450, the target number of replicas is limited within the range of the number of replicas. In some embodiments, the range of the number of replicas of the component may be determined based on scale factors specified by the scaling policy for the component. The scale factors may include a minimum scale factor and a maximum scale factor. The upper limit value and the lower limit value of the range of the number of replicas may be calculated by the following equations:

Lower limit value=current number of replicas*minimum scale factor

Upper limit value=current number of replicas*maximum scale factor.

Then, the target number of replicas is adjusted to the range of the number of replicas. For example, the target number of replicas v is adjusted according to the following equation:

v=max{lower limit value,min{upper limit value,v}}

At block 460, the target number of replicas is adjusted based on a downward/upward scaling indicator. It can be checked whether there is an indicator in the scaling policy for the component as to whether downward and/or upward scaling is allowed, and if the indicator exists, the target number of replicas can be adjusted based on the corresponding indicator and the current number of replicas of the component. For example, the target number of replicas may be adjusted based on the following equation:

$$v = \{ \begin{matrix}max \{ v , current number of replicas \} , & If downward scaling is not allowed \\ min \{ v , current number of replicas \} , & If upward scaling is not allowed \\ v , & Others\end{matrix}$$

It is noted that in some embodiments, if the target number of replicas is less than the current number of replicas, i.e., downward scaling is to occur, and the downward scaling indicator indicates that the component is not allowed to scale downward, then process 400 for that component may end directly. In addition, in the case where the determined target number of replicas is the same as the current number of replicas, process 400 may also end directly.

At block 470, the target number of replicas is set. Policy calculation submodule 233 may notify the calculated target number of replicas to result application submodule 234.

Process 400 may be executed repeatedly for each component of the application to obtain a target number of replicas for each component.

With continued reference to FIG. 3, at block 330, a configuration manifest of the application is updated based on the target number of replicas of the at least one component. In some embodiments, result application submodule 234 may update the target number of replicas of each component from policy calculation submodule 233 to the configuration manifest of the application. In some embodiments, the application may be a custom application managed by the k8s platform, and its components may be custom resources. The configuration manifest of the application includes a custom resource manifest, for example, a custom resource definition (CRD) in the yaml format provided by the k8s.

In some embodiments, result application submodule 234 checks the state of the node where the application is located, and, if the node is in a ready state, updates the number of replicas related to the component in the configuration manifest to the target number of replicas. Result application submodule 234 can also send a notification to the notification service of the cluster to start scaling.

Thereafter, dynamic scaling of the at least one component of the application can be performed based on the updated configuration manifest. In some embodiments, the number of container sets running the at least one component of the application is increased or decreased by a custom resource controller for the application. During the execution of the dynamic scaling, result application submodule 234 may also monitor the state of the dynamic scaling, and send a “scaling complete” notification to the notification service when the scaling is complete and a “scaling failed” notification when the scaling fails. In addition, a rollback operation is performed when needed.

Here, the custom resource controller may be a controller shared by a plurality of applications. Therefore, after the configuration manifest of the application is updated, automatic dynamic scaling can be performed based on a common process where the user only needs to provide configuration data to acquire the metrics and scaling policies of the components of the application to implement automate scaling of the components of the application.

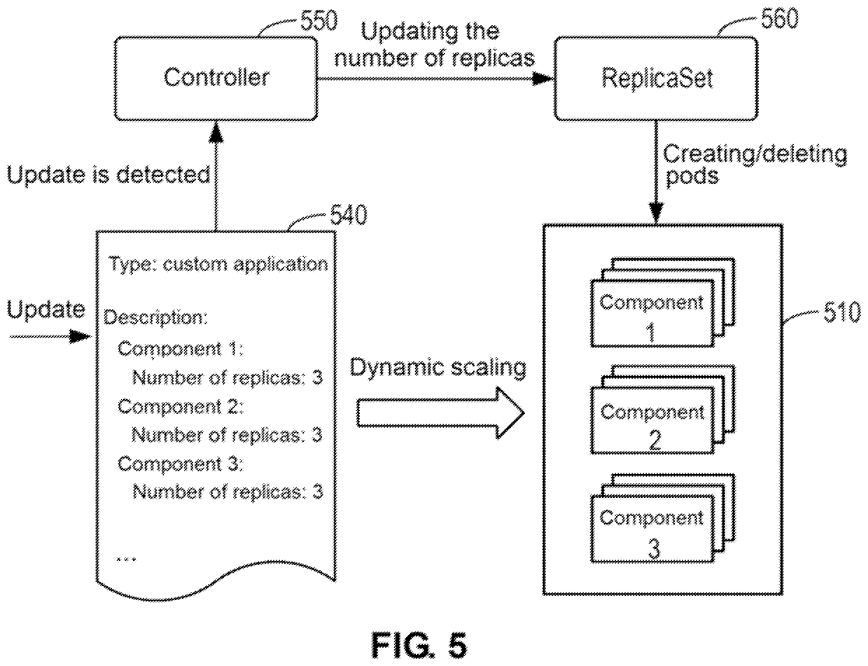

FIG. 5 illustrates a schematic diagram of a process for performing dynamic scaling based on a configuration manifest according to an embodiment of the present disclosure.

As shown, configuration manifest 540 has a type field which indicates that the application is a custom application. The configuration manifest also includes a description about the components of the application, including a desired number of replicas for each component. In response to an update operation initiated from result application submodule 234, configuration manifest 540 of the application is updated. Controller 550 (e.g., the custom resource controller of the k8s) detects the update of configuration manifest 540 and performs a preprocessing task. For example, if a component or resource is being updated or in a maintenance state, dynamic scaling can be refused, or some configurations can be updated or some additional resources can be created before a new pod is created to run a component replica.

Then, controller 550 updates the number of replicas for ReplicaSet object 560. As a result, the built-in controller of the k8s can create more pods in node 510 or delete pods. After the creation of the pods, some post-processing operations can be performed if desired.

The foregoing describes embodiments of the present disclosure with reference to FIG. 1 to FIG. 5. Compared with the prior art, in some embodiments of the present disclosure, the configuration manifest of the application can be automatically updated based on metric values of the components at runtime and the custom scaling policy, thereby achieving dynamic scaling of various components of the application without additional user effort to implement separate dynamic scaling mechanisms. In some embodiments, some embodiments of the present disclosure provide more flexible policies to meet the dynamic scaling needs of more complex applications. In addition, some embodiments of the present disclosure require only simple configuration to acquire custom metrics without building and deploying additional resources, thus providing better scalability and adaptability.

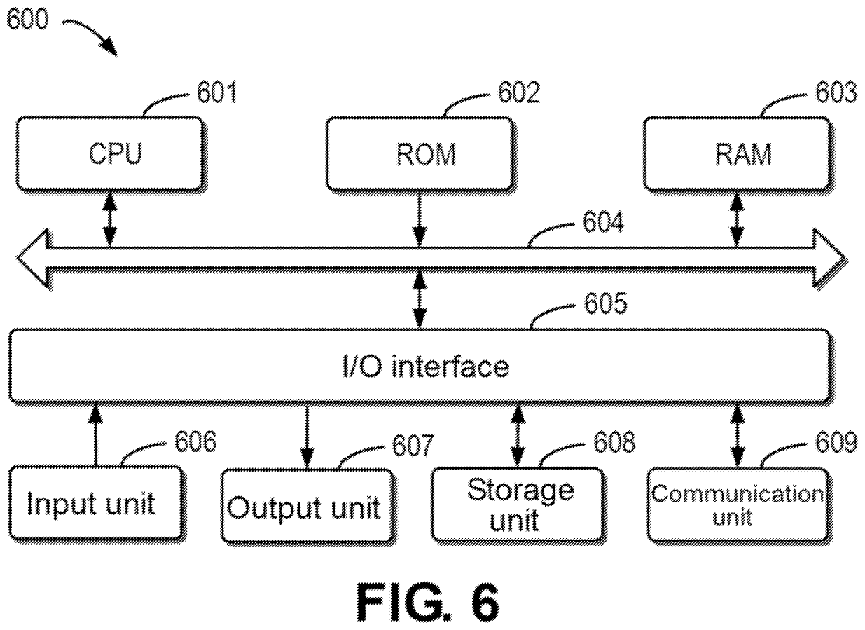

FIG. 6 illustrates a schematic block diagram of an example device that may be used to implement some embodiments of the present disclosure.

As shown in FIG. 6, device 600 includes central processing unit (CPU) 601 that may perform various appropriate actions and processing according to computer program instructions stored in read-only memory (ROM) 602 or computer program instructions loaded from storage unit 608 to random access memory (RAM) 603. Various programs and data required for the operation of device 600 may also be stored in RAM 603. CPU 601, ROM 602, and RAM 603 are connected to each other through bus 604. Input/output (I/O) interface 605 is also connected to bus 604.

A plurality of components in device 600 are connected to I/O interface 605, including: input unit 606, such as a keyboard and a mouse; output unit 607, such as various types of displays and speakers; storage unit 608, such as a magnetic disk and an optical disc; and communication unit 609, such as a network card, a modem, and a wireless communication transceiver. Communication unit 609 allows device 600 to exchange information/data with other devices via a computer network such as the Internet and/or various telecommunication networks.

The various processes and processing described above can be executed by processing unit 601. For example, in some embodiments, methods or processes may be implemented as a computer software program that is tangibly included in a machine-readable medium such as storage unit 608. In some embodiments, part of or all the computer program may be loaded and/or installed onto device 600 via ROM 602 and/or communication unit 609. One or more actions of methods or processes described above may be performed when the computer program is loaded into RAM 603 and executed by CPU 601.

The present disclosure may be a method, an apparatus, a system, and/or a computer program product. The computer program product may include a computer-readable storage medium on which computer-readable program instructions for performing various aspects of the present disclosure are loaded.

The computer-readable storage medium may be a tangible device that may retain and store instructions used by an instruction-executing device. For example, the computer-readable storage medium may be, but is not limited to, an electric storage device, a magnetic storage device, an optical storage device, an electromagnetic storage device, a semiconductor storage device, or any suitable combination of the foregoing. More specific examples (a non-exhaustive list) of the computer-readable storage medium include: a portable computer disk, a hard disk, a random access memory (RAM), a read-only memory (ROM), an erasable programmable read-only memory (EPROM or flash memory), a static random access memory (SRAM), a portable compact disc read-only memory (CD-ROM), a digital versatile disc (DVD), a memory stick, a floppy disk, a mechanical encoding device, for example, a punch card or a raised structure in a groove with instructions stored thereon, and any suitable combination of the foregoing. The computer-readable storage medium used herein is not to be interpreted as transient signals per se, such as radio waves or other freely propagating electromagnetic waves, electromagnetic waves propagating through waveguides or other transmission media (e.g., light pulses through fiber-optic cables), or electrical signals transmitted through electrical wires.

The computer-readable program instructions described herein may be downloaded from a computer-readable storage medium to various computing/processing devices or downloaded to an external computer or external storage device over a network, such as the Internet, a local area network, a wide area network, and/or a wireless network. The network may include copper transmission cables, fiber optic transmission, wireless transmission, routers, firewalls, switches, gateway computers, and/or edge servers. A network adapter card or network interface in each computing/processing device receives computer-readable program instructions from a network and forwards the computer-readable program instructions for storage in a computer-readable storage medium in each computing/processing device.

The computer program instructions for executing the operation of the present disclosure may be assembly instructions, instruction set architecture (ISA) instructions, machine instructions, machine-dependent instructions, microcode, firmware instructions, state setting data, or source code or object code written in any combination of one or a plurality of programming languages, the programming languages including object-oriented programming languages such as Smalltalk and C++, and conventional procedural programming languages such as the C language or similar programming languages. The computer-readable program instructions may be executed entirely on a user computer, partly on a user computer, as a stand-alone software package, partly on a user computer and partly on a remote computer, or entirely on a remote computer or a server. In a case where a remote computer is involved, the remote computer can be connected to a user computer through any kind of networks, including a local area network (LAN) or a wide area network (WAN), or can be connected to an external computer (for example, connected through the Internet using an Internet service provider). In some embodiments, an electronic circuit, such as a programmable logic circuit, a field programmable gate array (FPGA), or a programmable logic array (PLA), is customized by utilizing state information of the computer-readable program instructions. The electronic circuit may execute the computer-readable program instructions so as to implement various aspects of the present disclosure.

Various aspects of the present disclosure are described here with reference to flow charts and/or block diagrams of the method, the apparatus (system), and the computer program product according to the embodiments of the present disclosure. It should be understood that each block of the flow charts and/or the block diagrams and combinations of blocks in the flow charts and/or the block diagrams may be implemented by computer-readable program instructions.

These computer-readable program instructions may be provided to a processing unit of a general-purpose computer, a special-purpose computer, or a further programmable data processing apparatus, thereby producing a machine, such that these instructions, when executed by the processing unit of the computer or the further programmable data processing apparatus, produce means for implementing functions/actions specified in one or a plurality of blocks in the flow charts and/or block diagrams. These computer-readable program instructions may also be stored in a computer-readable storage medium, and these instructions cause a computer, a programmable data processing apparatus, and/or other devices to operate in a specific manner; and thus the computer-readable medium having instructions stored includes an article of manufacture that includes instructions that implement various aspects of the functions/actions specified in one or more blocks in the flow charts and/or block diagrams.

The computer-readable program instructions may also be loaded to a computer, a further programmable data processing apparatus, or a further device, so that a series of operating steps may be performed on the computer, the further programmable data processing apparatus, or the further device to produce a computer-implemented process, such that the instructions executed on the computer, the further programmable data processing apparatus, or the further device may implement the functions/actions specified in one or a plurality of blocks in the flow charts and/or block diagrams.

The flow charts and block diagrams in the drawings illustrate the architectures, functions, and operations of possible implementations of the systems, methods, and computer program products according to various embodiments of the present disclosure. In this regard, each block in the flow charts or block diagrams may represent a module, a program segment, or part of an instruction, the module, program segment, or part of an instruction including one or a plurality of executable instructions for implementing specified logical functions. In some alternative implementations, functions marked in the blocks may also occur in an order different from that marked in the accompanying drawings. For example, two successive blocks may actually be executed in parallel substantially, and sometimes they may also be executed in a reverse order, which depends on involved functions. It should be further noted that each block in the block diagrams and/or flow charts as well as a combination of blocks in the block diagrams and/or flow charts may be implemented using a dedicated hardware-based system that executes specified functions or actions, or using a combination of special hardware and computer instructions.

The embodiments of the present disclosure have been described above. The above description is illustrative, rather than exhaustive, and is not limited to the disclosed various embodiments. Numerous modifications and alterations are apparent to persons of ordinary skill in the art without departing from the scope and spirit of the illustrated embodiments. The selection of terms used herein is intended to best explain the principles and practical applications of the various embodiments or the improvements to technologies on the market, or to enable other persons of ordinary skill in the art to understand the embodiments disclosed here.

What is claimed is:

1. A method, comprising:
acquiring, by a system comprising a processor, a current value of a metric associated with components of an application;
determining a target number of replicas of at least one component of the components based on the current value of the metric and a scaling policy for the components; and
updating a configuration manifest of the application based on the target number of replicas of the at least one component, resulting in an updated configuration manifest.

2. The method according to claim 1, wherein acquiring the current value of the metric associated with the components of an application comprises:
determining a metric server based on a scaling configuration; and
acquiring the current value of the metric associated with the components from the metric server.

3. The method according to claim 1, wherein the scaling policy comprises a first target value of the metric and a second target value of a restriction, and determining the target number of replicas of the at least one component of the components comprises:
determining, based on a current number of replicas of the at least one component, the current value, and the first target value of the metric, a first number of replicas that satisfies the first target value of the metric;
determining, based on the current number of replicas of the at least one component, the current value, and the second target value of the restriction, a second number of replicas that satisfies the second target value of the restriction; and
determining the target number of replicas based on the first number of replicas and the second number of replicas.

4. The method according to claim 1, further comprising:
determining, based on scale factors specified by the scaling policy, a range of number of replicas of the at least one component; and
adjusting the target number of replicas to the range of the number of replicas.

5. The method according to claim 1, wherein the scaling policy further comprises an indicator as to whether at least one of downward or upward scaling is allowed, and the method further comprises:
adjusting the target number of replicas based on the indicator and a current number of replicas of the at least one component.

6. The method according to claim 1, wherein the metric associated with the components is a first metric, wherein the scaling policy for the components is a first scaling policy, wherein the acquiring, the determining and the updating are to support dynamic scaling, and further comprising:
acquiring a current value of a second metric associated with a node where the application is located; and
determining, based on the current value of the second metric associated with the node and a second scaling policy for the node, whether the dynamic scaling is allowed, wherein the second scaling policy for the node comprises a target value of the second metric associated with the node.

7. The method according to claim 1, wherein updating the configuration manifest of the application comprises:
checking the state of a node where the application is located; and
updating, in response to the node being in a ready state, a number of replicas related to the at least one component in the configuration manifest to the target number of replicas.

8. The method according to claim 1, wherein the application is a custom application managed by a open source container platform, the components are custom resources, and the configuration manifest of the application comprises a custom resource manifest.

9. The method according to claim 1, further comprising:
performing dynamic scaling of the at least one component based on the updated configuration manifest.

10. The method according to claim 9, wherein performing the dynamic scaling of the at least one component comprises:
increasing, by a custom resource controller, a number of container sets running the at least one component.

11. A device, comprising:
at least one processing unit; and
at least one memory coupled to the at least one processing unit and storing instructions for execution by the at least one processing unit, wherein the instructions, when executed by the at least one processing unit, cause the computing device to perform operations:
acquiring a current value of a metric associated with a group of components of an application;
determining a target number of replicas of at least one component of the group of components based on the current value of the metric and a scaling policy for the group of components; and
updating a configuration manifest of the application based on the target number of replicas of the at least one component.

12. The device according to claim 11, wherein acquiring a current value of a metric for the group of components of an application comprises:
determining a metric server based on a scaling configuration file; and
acquiring the current value of the metric for the group of components from the metric server.

13. The device according to claim 11, wherein the scaling policy comprises a target value of the metric and a target value of a restriction, and determining a target number of replicas of at least one component of the group of components comprises:
determining, based on a current number of replicas of the at least one component and the current value and the target value of the metric, a first number of replicas that satisfies the target value of the metric;
determining, based on the current number of replicas of the at least one component and a current value and the target value of the restriction, a second number of replicas that satisfies the target value of the restriction; and
determining the target number of replicas based on the first number of replicas and the second number of replicas.

14. The device according to claim 11, wherein the operations further comprise:
determining, based on scale factors specified by the scaling policy, a range of the number of replicas of the at least one component; and
adjusting the target number of replicas to the range of the number of replicas.

15. The device according to claim 11, wherein the scaling policy further comprises an indicator as to whether downward and/or upward scaling is allowed, and the operations further comprise:
adjusting the target number of replicas based on the indicator and a current number of replicas of the at least one component.

16. The device according to claim 11, wherein the operations further comprise:
acquiring a current value of a metric for a node where the application is located; and
determining, based on the current value of the metric for the node and a scaling policy for the node, whether the dynamic scaling is allowed, wherein the scaling policy for the node comprises a target value of the metric for the node.

17. The device according to claim 11, wherein updating the configuration manifest of the application comprises:
checking the state of a node where the application is located; and
updating, in response to the node being in a ready state, the number of replicas related to the at least one component in the configuration manifest to the target number of replicas.

18. The device according to claim 11, wherein the application is a custom application managed by a Kubernetes (k8s) platform, the group of components are custom resources, and the configuration manifest of the application comprises a custom resource manifest.

19. A computer program product comprising non-transitory machine-executable instructions that, when executed by a device, cause the device to perform operations comprising:
acquiring a current value of a metric associated with a plurality of components of an application;
determining a target number of replicas of at least one component of the plurality of components based on the current value of the metric and a scaling policy for the plurality of components; and
updating a configuration manifest of the application based on the target number of replicas of the at least one component.

20. The device according to claim 1, wherein the method further comprises:
performing dynamic scaling of the at least one component based on the updated configuration manifest comprising modifying, by a custom resource controller, a number of container sets running the at least one component.
